(19) United States
(12) Patent Application Publication
(10) Pub. No.: US 2011/0269891 A1
(43) Pub. Date: Nov. 3, 2011

(54) LONG-FIBER-REINFORCED POLYAMIDES WITH POLYOLEFINS

(75) Inventors: Sachin Jain, Mannheim (DE); Sameer Nalawade, Mannheim (DE); Andreas Wollny, Ludwigshafen (DE); Angelika Homes, Laudenbach (DE); Gerhard Leiter, Weinheim (DE); Matthias Scheibitz, Weinheim (DE)

(73) Assignee: BASF SE, Ludwigshafen (DE)

(21) Appl. No.: 13/097,683

(22) Filed: Apr. 29, 2011

Related U.S. Application Data
(60) Provisional application No. 61/329,570, filed on Apr. 30, 2010.

(51) Int. Cl. C08L 77/02; C08K 3/40; B82Y 30/00

(52) U.S. Cl. 524/494; 524/514; 977/773

(57) ABSTRACT

The invention relates to thermoplastic molding compositions comprising
A) from 10 to 89% by weight of a polyamide,
B) from 10 to 60% by weight of a fibrous reinforcing material with fiber length from 3 to 24 mm,
C) from 1 to 20% by weight of at least one polyolefin composed of ethylene or propylene or a mixture of these, where polar functional groups are excluded,
D) from 0 to 5% by weight of at least one nanoparticulate oxide or oxide hydrate, or a mixture of these, of at least one metal or semimetal, with a number-average primary-particle diameter of from 0.5 to 50 nm, and with a hydrophobic particle surface, and
E) from 0 to 40% by weight of further additives,
   where the entirety of components A) to E) gives 100%.

### CROSS-REFERENCE TO RELATED APPLICATIONS

This application claims benefit (under 35 USC 119(e)) of U.S. Provisional application 61/329,570, filed Apr. 30, 2010 which is incorporated by reference.

### BACKGROUND OF THE INVENTION

The invention relates to thermoplastic molding compositions comprising
A) from 10 to 89% by weight of a polyamide,
B) from 10 to 60% by weight of a fibrous reinforcing material with fiber length from 3 to 24 mm,
C) from 1 to 20% by weight of at least one polyolefin composed of ethylene or propylene or a mixture of these, where polar functional groups are excluded,
D) from 0 to 5% by weight of at least one nanoparticulate oxide or oxide hydrate, or a mixture of these, of at least one metal or semimetal, with a number-average primary-particle diameter of from 0.5 to 50 nm, and with a hydrophobic particle surface, and
E) from 0 to 40% by weight of further additives,
   where the entirety of components A) to E) gives 100%.

The invention further relates to the use of the thermoplastic molding compositions for producing long-fiber-reinforced pelletized materials, and to their resultant pelletized materials. The invention further relates to the use of pelletized materials of this type for producing moldings of any type, and to the resultant moldings.

Processes for producing long-fiber-reinforced molding compositions and pelletized materials are known by way of example from EP-A 1788027 and 1788028, and also 1788029.

The combination of good mechanical properties and in particular high HDT (heat distortion temperature) is achieved here via the constitution of the specific polyamide matrix with particular quantitative proportions of glass/polymer.

However, it is desirable to improve process speed with very substantial retention of mechanical properties.

### BRIEF SUMMARY OF THE INVENTION

A thermoplastic molding composition comprising
A) from 10 to 89% by weight of a polyamide,
B) from 10 to 60% by weight of a fibrous reinforcing material with fiber length from 3 to 24 mm,
C) from 1 to 20% by weight of at least one polyolefin composed of ethylene or propylene or a mixture of these, where polar functional groups are excluded,
D) from 0 to 5% by weight of at least one nanoparticulate oxide or oxide hydrate, or a mixture of these, of at least one metal or semimetal, with a number-average primary-particle diameter of from 0.5 to 50 nm, and with a hydrophobic particle surface, and
E) from 0 to 40% by weight of further additives,
   wherein components A) to E) does not exceed 100%.

### DETAILED DESCRIPTION OF THE INVENTION

The molding compositions defined in the introduction have accordingly been found. Preferred embodiments are found in the dependent claims.

Surprisingly, addition of a nonpolar polyolefin leads to an improvement in the feed time and the injection pressure for the mold during processing, although the polyolefin is not waxy (low Mₙ) and, being nonpolar, has poor miscibility with polyamides. Addition of a specific nanofiller provides a further processing improvement.

In the invention, the thermoplastic molding compositions comprise amounts of from 10 to 89% by weight, preferably from 15 to 88% by weight, and in particular from 15 to 70% by weight, of at least one thermoplastic polyamide as component A).

The intrinsic viscosity of the polyamides of the molding compositions of the invention is generally from 70 to 350 ml/g, preferably from 70 to 200 ml/g, determined at 25° C. in 96% strength by weight sulfuric acid to ISO 307.

Preference is given to the semicrystalline or amorphous resins with (weight-average) molecular weight of at least 5000 described by way of example in U.S. Pat. Nos. 2,071,250, 2,071,251, 2,130,523, 2,130,948, 2,241,322, 2,312,966, 2,512,606, and 3,393,210.

It is preferable to use polyamides which derive from lactams having from 7 to 13 ring members, e.g. polycaprolactam, polycaprylolactam, and polylaurolactam, or else polyamides obtained via reaction of dicarboxylic acids with diamines.

Dicarboxylic acids that can be used are alkanedicarboxylic acids having from 6 to 12, in particular from 6 to 10, carbon atoms, and aromatic dicarboxylic acids, in particular adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)methane, 2,2-di(4-aminophenyl)propane, 2,2-di(4-aminocyclo-hexyl)propane, or 1,5-diamino-2-methylpentane.

Preferred polyamides are polyhexamethyleneadipamide, polyhexamethylene-sebacamide, and polycaprolactam, and also nylon-6/6,6 copolyamides, in particular having from 5 to 95% by weight content of caprolactam units.

Other suitable polyamides are obtainable from w-aminoalkyl nitriles, such as, in particular, aminocapronitrile (PA 6) and adiponitrile with hexamethylenediamine (PA 66), by what is known as direct polymerization in the presence of water, as described by way of example in DE-A 10313681, EP-A 1198491, and EP 922065.

Mention may also be made of polyamides obtainable by way of example via condensation of 1,4-diaminobutane with adipic acid at an elevated temperature (nylon-4,6). Preparation processes for polyamides of said structure are described by way of example in EP-A 38 094, EP-A 38 582, and EP-A 39 524.

Other suitable polyamides are those obtainable via copolymerization of two or more of the abovementioned monomers, or a mixture of a plurality of polyamides, in any desired mixing ratio.

Semiaromatic copolyamides, such as PA 6/6T and PA 66/6T, have moreover proven particularly advantageous, especially those with a triamine content of less than 0.5% by weight, preferably less than 0.3% by weight (see EP-A 299 444).

The processes described in EP-A 129 195 and 129 196 can be used to produce the preferred semiaromatic copolyamides having low triamine content.

The preferred semiaromatic copolyamides A) comprise, as component a₁), from 40 to 90% by weight of units which derive from terephthalic acid and from hexamethylene diamine, based on component A). A small proportion of the terephthalic acid, preferably not more than 10% by weight of the entire aromatic dicarboxylic acids used, can be replaced by isophthalic acid or by other aromatic dicarboxylic acids, preferably those in which the carboxy groups are in para-position.

The semiaromatic copolyamides comprise, alongside the units that derive from terephthalic acid and from hexamethylenediamine, units (a₂) which derive from ε-caprolactam and/or units (a₃) which derive from adipic acid and from hexamethylenediamine.

The proportion of units that derive from ε-caprolactam is at most 50% by weight, preferably from 20 to 50% by weight, and in particular from 25 to 40% by weight, while the proportion of units that derive from adipic acid and from hexamethylenediamine is up to 60% by weight, preferably from 30 to 60% by weight, and in particular from 35 to 55% by weight, based in each case on component A).

The copolyamides can also comprise not only units of ε-caprolactam but also units of adipic acid and hexamethylenediamine; in this case, it is advantageous that the proportion of units free from aromatic groups is at least 10% by weight, preferably at least 20% by weight, based on component A). There is no particular restriction here on the ratio of the units which derive from ε-caprolactam and from adipic acid and hexamethylenediamine.

Polyamides that have proven particularly advantageous for many applications are those having from 50 to 80% by weight, in particular from 60 to 75% by weight, of units which derive from terephthalic acid and hexamethylenediamine (units a₁)) and from 20 to 50% by weight, preferably from 25 to 40% by weight, of units which derive from ε-caprolactam (units a₂)), based in each case on component A).

The semiaromatic copolyamides A) of the invention can also comprise, alongside the units a₁) to a₃) described above, subordinate amounts, preferably no more than 15% by weight, in particular no more than 10% by weight, of further polyamide units (a₄) known from other polyamides. These units can derive from dicarboxylic acids having from 4 to 16 carbon atoms and from aliphatic or cycloaliphatic diamines having from 4 to 16 carbon atoms, or else from aminocarboxylic acids and, respectively, corresponding lactams having from 7 to 12 carbon atoms. Just a few examples of suitable monomers of these types may be mentioned: suberic acid, azelaic acid, sebacic acid, or isophthalic acid to represent the dicarboxylic acids, and 1,4-butanediamine, 1,5-pentanediamine, piperazine, 4,4′-diaminodicyclohexylmethane, 2,2-(4,4′-diaminodicyclohexyl)propane or 3,3′-dimethyl-4,4′-diaminodicyclohexylmethane to represent the diamines, and caprylolactam, enantholactam, omega-aminoundecanoic acid, and laurolactam to represent lactams and, respectively, aminocarboxylic acids.

The melting points of the semiaromatic copolyamides A) are in the range from 260 to above 300° C., and this high melting point also has an attendant high glass transition temperature which is generally above 75° C., in particular above 85° C.

Binary copolyamides based on terephthalic acid, hexamethylenediamine and ε-caprolactam, with contents of about 70% by weight of units which derive from terephthalic acid and hexamethylenediamine, have melting points in the region of 300° C. and glass transition temperature above 110° C.

Binary copolyamides based on terephthalic acid, adipic acid, and hexamethylene-diamine (HMD) achieve melting points of 300° C. and more even at relatively low contents of about 55% by weight of units composed of terephthalic acid and hexamethylenediamine, but the glass transition temperature is not quite as high as for binary copolyamides which comprise ε-caprolactam instead of adipic acid or, respectively, adipic acid/HMD.

The following list, which is not comprehensive, comprises the polyamides A) mentioned and other polyamides A) for the purposes of the invention, and the monomers comprised.

### AB Polymers:

PA 4 Pyrrolidone
PA 6 ε-Caprolactam
PA 7 Ethanolactam
PA 8 Caprylolactam
PA 9 9-Aminopelargonic acid
PA 11 11-Aminoundecanoic acid
PA 12 Laurolactam

### AA/BB Polymers:

PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA 9T Nonyldiamine/terephthalic acid
PA MXD6 m-Xylylenediamine, adipic acid
PA 6I Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 6I/6T (see PA 6I and PA 6T)
PA PACM 12 Diaminodicyclohexylmethane, laurolactam
PA 6I/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

However, it is also possible to use a mixture of above polyamides.

The amounts used of the fibrous fillers B) are from 10 to 60% by weight, in particular from 15 to 50% by weight, preferably from 20 to 50% by weight.

Preferred fibrous fillers that may be mentioned are carbon fibers, aramid fibers, glass fibers, and potassium titanate fibers, particular preference being given to glass fibers in the form of E glass. These are used in the form of rovings, in the forms commercially available.

The diameter of the glass fibers used as roving in the invention is from 6 to 20 μm, preferably from 10 to 18 μm, and the cross section of these glass fibers is round, oval, or angular. In particular, E glass fibers are used in the invention. However, it is possible to use any of the other types of glass fiber, examples being A, C, D, M, S, or R glass fibers, or any desired mixture thereof, or a mixture with E glass fibers.

The fibrous fillers can have been surface-pre-treated with a silane compound, in order to improve compatibility with the thermoplastic.

Suitable silane compounds are those of the general formula

(X—(CH₂)ₙ)ₖ—Si—(O—CₘH₂ₘ₊₁)₄₋ₖ

where the definitions of the substituents are as follows:

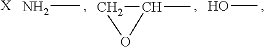

and
n is an integer from 2 to 10, preferably from 3 to 4
m is an integer from 1 to 5, preferably from 1 to 2
k is an integer from 1 to 3, preferably 1.

Preferred silane compounds are aminopropyltrimethoxysilane, aminobutyltrimethoxy-silane, aminopropyltriethoxysilane, aminobutyltriethoxysilane, also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on E)).

Other suitable coating compositions (also termed sizes) are based on isocyanates.

The L/D (length/diameter) ratio is preferably from 100 to 4000, in particular from 350 to 2000, and very particularly from 350 to 700.

In the invention, the thermoplastic molding compositions comprise, as component C), from 1 to 20% by weight, preferably from 2 to 15% by weight, and in particular from 5 to 15% by weight, of at least one polyolefin composed of repeat units selected from ethylene and propylene, or from a mixture of these, with exclusion of polar functional groups.

Polar functional groups are any of the functional groups that are present within incorporated monomer units and which include atoms other than carbon and hydrogen. The polyolefins of the invention are therefore composed of the monomer units ethylene and propylene, with exclusion of comonomers and/or functional groups comprising atoms other than C and H, and also with exclusion of unsaturated groups.

However, the polyolefins of component C) can comprise conventional branching and also, to a small extent, in particular to an extent of up to 2% by weight, further monomer units composed of C and of H. The polyolefins of component B) can therefore comprise small amounts of other monomer units such as those derived from 1-butene, from 1-pentene, from 1-hexene, from 1-heptene, or from 1-octene, or from 4-methyl-1-pentene.

It is essential to the invention here that the polyolefin has not been modified via functional groups. In other words, the polyolefin does not include any functional monomer units which bear acid groups or which bear other hydrophilic groups. Nor does the polyolefin have modification via unsaturated groups.

The thermoplastic molding compositions therefore comprise, as component C), at least one linear or branched polyolefin consisting essentially of repeat units selected exclusively from ethylene and from propylene.

The polyolefins used in the invention are obtainable via polymerization of at least one of the monomers ethylene and propylene.

Components C) that can be used are in particular polyolefins selected from the group of low-density polyethylene (LDPE), very low-density polyethylene (VLDPE), high-density polyethylene (HDPE), linear low-density polyethylene (LLDPE), isotactic polypropylene, atactic polypropylene, and syndiotactic polypropylene. Component C) is preferably a homopolyethylene.

To the extent that the present invention concerns polyethylene, this means a homopolymer of ethylene which can have branching, in particular linear branching; analogous considerations apply to polypropylene.

Low-density polyethylene (LDPE) here means a material with density from 0.91 to 0.94 g/cm³. The density of high-density polyethylenes (HDPEs) is generally from 0.94 to 0.965 g/cm³. Very low-density polyethylenes have densities below 0.918 g/cm³.

LDPE is preferably obtained via free-radical polymerization of ethylene. Polymerization of ethylene can by way of example be achieved via free-radical polymerization in high-pressure reactors at pressures of about 150 to 200 MPa and at average temperatures of about 200° C. or above. When the reaction is conducted in this way, chain-transfer mechanisms produce low-density polyethylene (LDPE) with molar mass of about 50 000 to 150 000 g/mol (M_{w}).

High-pressure processes can likewise be used to produce linear low-density polyethylene (LLDPE) and very low-density polyethylene (VLDPE). These materials are usually translucent, white, flexible solids, which can be processed to give films that are transparent or that sometimes also have a slight milky haze.

High-density polyethylenes can by way of example be produced in low-pressure reactors, using transition metal catalysts. Among these are by way of example the Phillips catalyst, such as chromium-trioxide-impregnated quartz particles, or compounds which are in principle similar, such as bis(triphenylsilyl) chromate or chromacene (dicyclopentadienylchromium). The Ziegler catalysts are likewise within the transition metal catalysts group, and generally include titanium alkoxylates and long-chain alkylaluminum compounds. Both groups of catalyst can be used to produce unbranched polyethylenes with high tendency toward crystallization and therefore high density. The resultant materials are usually opaque, white materials with low flexibility. Residual content of catalyst material is usually about 20 ppm.

Component C) is preferably an LDPE.

To the extent that low-density polyethylene (LDPE) is used, its density (23° C.) is preferably from 0.910 to 0.925 g/cm³, preferably from 0.915 to 0.925 g/cm³, and its MFI to ISO 1133 (190° C./2.16 kg) is preferably from 0.5 to 2.0 g/10 min, particularly preferably from 0.6 to 1.2 g/10 min. The molar mass Mw of preferred LDPE is from 50 000 to 150 000 g/mol, in particular from 60 000 to 130 000 g/mol.

The molding compositions in the invention can comprise, as component D), amounts of from 0 to 5% by weight, preferably from 0.05 to 4% by weight, and in particular from 0.1 to 3% by weight, of at least one nanoparticulate oxide and/or oxide hydrate of at least one metal or semimetal, with a number-average primary-particle diameter of from 0.5 to 50 nm and with a hydrophobic particle surface.

Appropriate oxides and/or oxide hydrates with a hydrophobic particle surface are known per se to the person skilled in the art.

Component D) can in particular be characterized on the basis of at least one of the following features a) and/or b):
a) Component D) is at least one nanoparticulate oxide and/or oxide hydrate of at least one metal or semimetal, with a number-average primary-particle diameter of from 0.5 to 50 nm, where transmission electron microscopy shows that the oxide and/or oxide hydrate is present exclusively in component B or at the interface of component B) with component A).

Component D) and component (C) form a first phase here, while component (A) forms a separate second phase. Methods for determining phases in polymer mixtures and determining nanoparticulate constituents in polymer mixtures are known to the person skilled in the art. For the purposes of the present invention, the phases and constituents of these are determined by transmission electron microscopy.
b) The methanol-wettability of component D) is at least 50%.

Methanol-wettability measures the hydrophobicity of an oxide and/or oxide hydrate of at least one metal or semimetal. The method wets oxides and/or oxide hydrates with a methanol/water mixture. The proportion of methanol in the mixture, expressed as percent by weight, is a measure of the water-repellency of the metal oxide. The higher the proportion of methanol, the greater the hydrophobization of the substance.

Titration is used to determine the level of hydrophobicity. For this, 0.2 g of the specimen is weighed into a 250 ml separating funnel, and 50 ml of ultrapure water are added. The oxide or oxide hydrate with hydrophobic surface remains on the surface of the water. Methanol is now added ml-wise from a burette. During this process, the separating funnel is shaken by hand with a circular motion, avoiding production of any turbulence within the liquid. This method is used to add methanol until the powder is wetted. This is discernible in that all of the powder sinks from the surface of the water. The amount of methanol consumed is converted to % by weight of methanol and stated as methanol-wettability value.

The number-average diameter of the primary particles in the thermoplastic molding composition is determined by transmission electron microscopy followed by image analysis, using a statistically significant number of specimens. The person skilled in the art is aware of appropriate methods.

The BET surface area of oxides with hydrophobic particle surface is generally at most 300 m²/g to DIN 66131. The BET specific surface area of component D) to DIN 66131 is preferably from 50 to 300 m²/g, in particular from 100 to 250 m²/g.

The metal and/or semimetal of component D) is preferably silicon. The thermoplastic molding compositions of the invention preferably comprise, as component D), a nanoparticulate oxide and/or oxide hydrate of silicon with a number-average primary-particle diameter of from 0.5 to 50 nm, in particular from 1 to 20 nm.

Component D) is particularly preferably fumed nanoparticulate silicon dioxide, the surface of which has been hydrophobically modified.

It is particularly preferable that component D) has a number-average primary-particle diameter of from 1 to 20 nm, with preference from 1 to 15 nm.

In one preferred embodiment, component D) has been hydrophobically modified by a surface modifier, preferably an organosilane.

The surface can be modified by bringing the nanoparticles, preferably in the form of suspension, or undiluted, into contact with a surface modifier, for example by spraying.

In particular, the nanoparticles can be sprayed first with water and then with the surface modifier. The reverse spraying sequence can also be used. The water used can have been acidified with an acid, such as hydrochloric acid, until pH is from 7 to 1. If a plurality of surface modifiers are used, these can be applied in the form of a mixture or separately, simultaneously, or in sequence.

The surface modifier(s) can have been dissolved in suitable solvents. Once the spraying process has ended, mixing can be continued for from 5 to 30 minutes. The mixture is then preferably heat-treated for a period of from 0.1 to 6 h at a temperature of from 20 to 400° C. The heat treatment can take place under inert gas, such as nitrogen.

In a possible alternative method for surface-modification of the silicas, the silicas are treated with the surface modifier in vapor form, and the mixture is then heat-treated for a period of from 0.1 to 6 h at a temperature of from 50 to 800° C. The heat treatment can take place under inert gas, such as nitrogen. The heat treatment can also take place in a plurality of stages at different temperatures. The surface modifier(s) can be applied using single- or double-fluid nozzles, or using ultrasound nozzles.

A possible method of surface modification uses heatable mixers and dryers with spray equipment, continuously or batchwise. Examples of suitable apparatuses can be: plowshare mixers, pan dryers, or fluidized-bed dryers.

DE 10 2007 035 951 A1, paragraph [0015], describes surface modifiers that can be used with advantage for the purposes of the present invention.

The following silanes can be used with preference as surface modifiers: octyltrimethoxysilane, octyltriethoxysilane, 3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoqsilane, aminopropyltriethoxysilane, hexamethyldisilazane.

It is particularly preferable to use hexamethyldisilazane, hexadecyltrimethoxysilane, dimethylpolysiloxane, octyltrimethoxysilane, and octyltriethoxysilane.

In particular, those used are hexamethyldisilazane, octyltrimethoxysilane, and hexadecyltrimethoxysilane, very particular preference being given to hexamethyldisilazane.

The thermoplastic molding compositions of the invention can moreover comprise, as component E), further additives which differ from A) to D).

The molding compositions of the invention can comprise, based on the total amount of components A) to E), a total of from 0 to 40% by weight, in particular up to 30% by weight, of further additives and processing aids.

The thermoplastic molding compositions advantageously comprise a lubricant. The molding compositions of the invention can comprise, as component E), from 0 to 3% by weight, preferably from 0.05 to 3% by weight, with preference from 0.1 to 1.5% by weight, and in particular from 0.1 to 1% by weight, of a lubricant, based on the total amount of components A) to E).

Preference is given to the Al, alkali metal, or alkaline earth metal salts, or esters or amides of fatty acids having from 10 to 44 carbon atoms, preferably having from 14 to 44 carbon atoms. The metal ions are preferably alkaline earth metal and Al, particular preference being given to Ca or Mg. Preferred metal salts are Ca stearate and Ca montanate, and also Al stearate. It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The thermoplastic molding compositions of the invention can comprise, as further component E), conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and other amines (e.g. TAD), hydroquinones, various substituted representatives of these groups, and mixtures of these, in concentrations of up to 1% by weight, based on the weight of the thermoplastic molding compositions.

UV stabilizers that may be mentioned, where the amounts used of these are generally up to 2% by weight, based on the molding composition, are various substituted resorcinols, salicylates, benzotriazoles, and benzophenones.

Colorants that can be added are inorganic pigments, such as titanium dioxide, ultramarine blue, iron oxide, and carbon black, and/or graphite, and also organic pigments, such as phthalocyanines, quinacridones, perylenes, and also dyes, such as nigrosin, and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame-retardant systems, and synergists of these.

The thermoplastic molding compositions can comprise, as component E), from 0.01 to 2% by weight, preferably from 0.05 to 1.5% by weight, particularly preferably from 0.1 to 1.5% by weight, of at least one heat stabilizer, based in each case on the total weight of components A) to E).

In one preferred embodiment, the heat stabilizers have been selected from the group consisting of
(a) compounds of mono- or divalent copper, e.g. salts of mono- or divalent copper with inorganic or organic acids, or with mono- or dihydric phenols, the oxides of mono- or divalent copper, or the complexes of copper salts with ammonia, with amines, with amides, with lactams, with cyanides, or with phosphines, preferably Cu(I) or Cu(II) salts of the hydrohalic acids, of the hydrocyanic acids, or the copper salts of the aliphatic carboxylic acids. Particular preference is given to the monovalent copper compounds CuCl, CuBr, CuI, CuCN, and Cu₂O, and also to the divalent copper compounds CuCl₂, CuSO₄, CuO, copper(II) acetate, or copper(II) stearate. If a copper compound is used, the amount of copper compound is preferably from 0.005 to 0.5% by weight, in particular from 0.005 to 0.3% by weight, and particularly preferably from 0.01 to 0.2% by weight, based on the entirety of components A) to E).
   The copper compounds are commercially available, or their preparation is known to the person skilled in the art. The copper compound can be used as it stands or in the form of a concentrate. A concentrate here is a polymer, preferably one whose chemical nature is identical with that of component (A), where the polymer comprises a high concentration of the copper salt. The use of concentrates is a conventional process and is particularly frequently applied when very small amounts of a starting material have to be metered. The copper compounds are advantageously used in combination with further metal halides, in particular alkali metal halides, e.g. NaI, KI, NaBr, KBr, where the molar ratio of metal halide to copper is from 0.5 to 20, preferably from 1 to 10, and particularly preferably from 2 to 5.
(b) Stabilizers based on secondary aromatic amines, where the amount present of these stabilizers is preferably from 0.2 to 2% by weight, with preference from 0.5 to 1.5% by weight,
(c) stabilizers based on sterically hindered phenols, where the amount present of these stabilizers is preferably from 0.05 to 1.5% by weight, with preference from 0.1 to 1% by weight, and
(d) mixtures of the abovementioned stabilizers.

Stabilizers based on secondary aromatic amines are known per se to the person skilled in the art and can be used with advantage for the purposes of the present invention.

The amount preferably present of stabilizers based on secondary aromatic amines is from 0.2 to 2% by weight, in particular from 0.5 to 1.5% by weight, based on the total weight of the thermoplastic molding composition. WO2008/022910, page 9, line 36 to page 10, prior to line 3 describes particularly preferred stabilizers based on secondary aromatic amines.

Stabilizers based on sterically hindered phenols are likewise known per se to the person skilled in the art. The amount preferably present of stabilizers based on sterically hindered phenols is from 0.05 to 1.5% by weight, in particular from 0.1 to 1% by weight, based on the total weight of the thermoplastic molding composition. WO2008/022910, page 10, line 3 to page 11, prior to line 10 describes particularly preferred stabilizers based on sterically hindered phenols.

The polyamide molding compositions of the invention can be produced via the known processes for producing elongate pellets of long-fiber-reinforced material, in particular via pultrusion processes, where the continuous-filament fiber strand (roving) is completely saturated by the polymer melt and is then cooled and chopped. The elongate long-fiber-reinforced pellets thus obtained, preferably with pellet length of from 3 to 25 mm, in particular from 5 to 14 mm, can be further processed by the conventional processing methods (e.g. injection molding, compression molding), to give moldings.

The preferred L/D ratio of the pellets after pultrusion is from 2 to 8, in particular from 3 to 4.5.

Particularly good properties can be achieved in moldings by using non-aggressive processing methods. Non-aggressive in this context means mainly substantial avoidance of excessive fiber breakage with the attendant marked reduction in fiber length. In the case of injection molding, this means that it is preferable to use screws with large diameter and low compression ratio, in particular smaller than 2, and generous internal dimensions of nozzles and runners. Supplementary requirements are that high cylinder temperatures are used to achieve rapid melting (contact heating) of the elongate granulated materials, and that excessive comminution of the fibers due to excessive shear is avoided. If these measures are implemented, the invention gives moldings which have higher average fiber length than comparable moldings produced from short-fiber-reinforced molding compositions. This achieves additionally improved properties, in particular tensile strength, modulus of elasticity, ultimate tensile strength, and notched impact resistance.

After processing to give the molding, e.g. via injection molding, fiber length is usually from 0.5 to 10 mm, in particular from 1 to 3 mm.

The polymer strand produced from the molding compositions of the invention can be processed to give pellets by any of the known pelletization methods, e.g. strand pelletization, where the strand is cooled in a water bath and then chopped. If fiber content is more than 50% by weight, it is advisable, in order to improve pellet quality, to use underwater pelletization or underwater die-face pelletization, where the polymer melt is directly forced through a pelletizing die and is pelletized by a rotating knife in a current of water.

The moldings produced from the molding compositions of the invention are used to produce internal and external parts, preferably with a load-bearing or mechanical function, in the following sectors: electrical, furniture, sports, mechanical engineering, sanitary and hygiene, medical, energy technology, and drive technology, automobiles and other conveyances, and casing material for devices and apparatuses for telecommunications, consumer electronics, household appliances, mechanical engineering, or the heating sector, or fastener components for installation work or for containers, and ventilation components of all types.

There is an overall improvement in processing speed, with very little impairment of mechanical properties.

### Processing Methods

The following processing methods can be used, alongside the conventional processing methods, such as extrusion or injection molding:
CoBi injection or assembly injection molding for hybrid components, where the polyamide molding composition of the invention is combined with other compatible or incompatible materials, e.g. thermoplastics, thermosets, or elastomers.
Insert components, such as bearings or screw-thread inserts made of the polyamide molding composition of the invention, overmolded with other compatible or incompatible materials, e.g. thermoplastics, thermosets, or elastomers.
Outsert components, such as frames, casings, or struts made of the polyamide molding composition of the invention, into which functional elements made of other compatible or incompatible materials, e.g. thermoplastics, thermosets, or elastomers, are injected.
Hybrid components (elements made of the polyamide molding composition combined with other compatible or incompatible materials, e.g. thermoplastics, thermosets, or elastomers) produced via composite injection molding, injection welding, assembly injection molding, ultrasound welding, frictional welding, or laser welding, adhesive bonding, beading, or riveting.
Semifinished products and profiles (e.g. produced via extrusion, pultrusion, layering, or lamination).
Surface coating, doubling methods, chemical or physical metallization, or flocking, where the polyamide molding composition of the invention can be the substrate itself or the substrate support, or, in the case of hybrid/bi-injection components, can be a defined substrate region, which can also be brought to the surface via subsequent chemical treatment (e.g. etching) or physical treatment (e.g. machining or laser ablation).
Printing, transfer print, 3D print, laser inscription.

### Examples

The following components were used:

Component A: nylon-6 with intrinsic viscosity IV to ISO 307 of 140 ml/g prior to extrusion.
Component B: glass-fiber roving, Ø 17 μm.
Component C: Lupolen® A2420K, an unmodified LDPE with density (ISO 1183) of 0.924 g/cm³, Shore D hardness (ISO 868) of 48, and melt flow rate MFR (ISO 1133) of 4 g/10 min (190° C., 2.16 kg).
Component D: Aerosil® R8200, a hydrophobically modified fumed SiO₂ with average particle size 15 nm (transmission electron microscopy), with a hexamethyldisilazane-hydrophobized particle surface, specific BET surface area of about 160 m²/g, and pH of at least 5 for a 4% strength dispersion.
Component E/1: calcium stearate.
Component E/2: CuI:KI (molar ratio 1:4).

The molding compositions were produced as follows:

| | | |
|---|---|---|
| 1) | Pultrusion conditions: | |
| | Extruder temperature setting | 285° C. |
| | Impregnation chamber | 290° C. |
| | Preheating of rovings | 180° C. |
| | Take-off speed | 9 to 12 m/min |
| | Pellet length | 12 mm |
| | Pellet L/D | 4 |
| 2) | Glass fiber L/D after injection molding | 120 |

The test specimens used to determine the properties were obtained by means of injection molding (injection temperature 280° C., melt temperature 80° C.).
3) Charpy impact resistance was determined without notch at −30° C. to ISO 179-2/1eU. The intrinsic viscosity of the polyamides was measured to DIN 53 727 on 0.5% strength by weight solutions in 96% by weight sulfuric acid.
4) Feed time to DIN 24445 is the time required for complete filling of a test box with the polymer melt.
5) Injection pressure (melt pressure).

Hydraulic pressure was recorded and noted during the experiments. This can then be converted to specific pressure (melt pressure) (EN ISO 294-1 (1996)).

Melt pressure p: the pressure of the plastics molding composition at the tip of the screw at any juncture during the injection-molding process. It is stated in megapascals (MPa). (1 MPa [symbol] 10 bar)

Melt pressure is calculated from equation (1)

$$p = \frac{( 4 \cdot {10}^{3} \cdot {F}_{s} )}{π \cdot {D}^{2}}$$

using the axial force Fₛ, for example generated hydraulically, acting on the screw.

The variables here are as follows:

P is melt pressure in MPa
Fₛ is axial force on the screw in kilonewtons
D is screw diameter in millimeters

The constitutions of the molding compositions and the results of the measurements are found in the table.

| Components | Example | | |
|---|---|---|---|
| [% by wt.] | 1 comp | Example 2 | Example 3 |
| A) | 69.575 | 59.575 | 58.075 |
| B) | 30 | 30 | 30 |
| C) | — | 10 | 10 |
| D) | — | — | 1.5 |
| E/1) | 0.15 | 0.15 | 0.15 |
| E/2) | 0.275 | 0.275 | 0.28 |
| Modulus of elasticity [MPa] | 10131 | 8967 | 9389 |
| Tensile strength [MPa] | 196.8 | 176 | 189 |
| Tensile strain at break [%] | 2.49 | 2.96 | 2.45 |
| Charpy without notch [kJ/m²] | | | |
| RT | 68.8 | 81 | 83 |
| −30° C. | 53 | 58 | 58 |
| Feed time [sec] | 7.4 | 6.3 | 5.1 |
| Melt pressure [MPa] | 4.5 | 3.5 | 3.5 |

1.-11. (canceled)

12. A thermoplastic molding composition comprising
A) from 10 to 89% by weight of a polyamide,
B) from 10 to 60% by weight of a fibrous reinforcing material with fiber length from 3 to 24 mm,
C) from 1 to 20% by weight of at least one polyolefin composed of ethylene or propylene or a mixture of these, where polar functional groups are excluded,
D) from 0 to 5% by weight of at least one nanoparticulate oxide or oxide hydrate, or a mixture of these, of at least one metal or semimetal, with a number-average primary-particle diameter of from 0.5 to 50 nm, and with a hydrophobic particle surface, and
E) from 0 to 40% by weight of further additives,
wherein components A) to E) does not exceed 100%.

13. The thermoplastic molding composition according to claim 12, comprising
A) 15 to 88% by weight
B) 10 to 60% by weight
C) 1 to 20% by weight
D) 0.05 to 4% by weight and
E) 0 to 30% by weight
wherein the entirety of components A) to E) gives 100%.

14. The thermoplastic molding composition according to claim 12, wherein component B) is composed of glass fibers.

15. The thermoplastic molding composition according to claim 12, in which the L/D ratio of component B) is from 100 to 4000.

16. The thermoplastic molding composition according to claim 13, wherein component B) is composed of glass fibers and the L/D ratio of component B) is from 100 to 4000.

17. The thermoplastic molding composition according to claim 12, in which component C) is composed of an low density polyethylene.

18. The thermoplastic molding composition according to claim 16, in which component C) is composed of an low density polyethylene.

19. The thermoplastic molding composition according to claim 12, in which the BET specific surface area of component D) to DIN 66131 is from 50 to 300 m²/g.

20. The thermoplastic molding composition according to claim 18, in which the BET specific surface area of component D) to DIN 66131 is from 50 to 300 m²/g.

21. A process for producing long-fiber-reinforced pelletized materials which comprises utilizing the thermoplastic molding compositions according to claim 12.

22. A long-fiber-reinforced pelletized material obtainable from the thermoplastic molding compositions according to claim 12.

23. The pelletized material according to claim 22, which has an L/D ratio of from 2 to 8.

24. A process for producing moldings which comprises utilizing the pelletized material according to claim 22.

25. A molding obtainable from the pelletized materials according to claim 22.
